(19) United States
(12) Patent Application Publication
(10) Pub. No.: US 2021/0245137 A1
(43) Pub. Date: Aug. 12, 2021

(54) CORE-SHELL IRON OXIDE-POLYMER NANOFIBER COMPOSITES FOR REMOVAL OF HEAVY METALS FROM DRINKING WATER

(71) Applicants: THE REGENTS OF THE UNIVERSITY OF CALIFORNIA, Oakland, CA (US); UNIVERSITY OF IOWA RESEARCH FOUNDATION, Iowa City, IA (US)

(72) Inventors: Nosang Myung, Oakland, CA (US); David Cwiertny, Iowa City, IA (US); Katherine Greenstein, Iowa City, IA (US); Gene Parkin, Iowa City, IA (US)

(73) Assignees: THE REGENTS OF THE UNIVERSITY OF CALIFORNIA, Oakland, CA (US); UNIVERSITY OF IOWA RESEARCH FOUNDATION, Iowa City, IA (US)

(21) Appl. No.: 16/972,958

(22) PCT Filed: Jun. 7, 2019
(86) PCT No.: PCT/US2019/036079

§ 371 Date: Dec. 7, 2020

Related U.S. Application Data
(60) Provisional application No. 62/682,654, filed on Jun. 8, 2018.

(51) Int. Cl. B01J 20/26; B01J 20/28; B01J 20/32; B01J 20/30; C02F 1/28; C23C 18/12; D01D 5/00; D01F 8/08; D01F 8/18

(52) U.S. Cl. CPC B01J 20/261; C02F 2101/103; B01J 20/321; B01J 20/3236; B01J 20/3295; B01J 20/28007; B01J 20/28028; B01J 20/28038; B01J 20/3078; B01J 20/28004; C02F 1/288; C23C 18/1216; C23C 18/1237; C23C 18/1245; D01D 5/0007; D01F 8/08; D01F 8/18; B01J 2220/46; C02F 1/285; C02F 1/281; C02F 2305/08; B01J 20/28011

(57) ABSTRACT

A method is disclosed of forming core-shell iron oxide-polymer nanofiber composites. The method includes synthesizing composite nanofibers of polyacrylonitrile (PAN) with embedded hematite (α-Fe₂O₃) nanoparticles via a single-pot electrospinning synthesis; and generating a core-shell nanofiber composite through a subsequent hydrothermal growth of α-Fe₂O₃ nanostructures on the composite nanofibers of polyacrylonitrile (PAN) with the embedded hematite (α-Fe₂O₃) nanoparticles.

### CROSS-REFERENCE TO RELATED APPLICATION

This application claims priority to U.S. Provisional Application No. 62/682,654, filed Jun. 8, 2018, the entire content of which is incorporated herein by reference.

### GOVERNMENT CLAUSE

This invention was made with government support under contract number R83517701 awarded by the Environmental Protection Agency. The government has certain rights in this invention.

### TECHNICAL FIELD

The disclosure relates to core-shell iron oxide-polymer nanofiber composites for removal of heavy metals from drinking water.

### BACKGROUND

Many communities continue to struggle with contamination of drinking water from heavy metals and metalloids including, for example, (i) high levels of lead (Pb) in Flint, Mich.; (ii) frequent detection of arsenic (As) above the US EPA maximum contaminant level (MCL) in groundwater wells in Iowa; and (iii) the detection of hexavalent chromium (Cr(VI)) in the tap water of 31 (of 35) cities across the United States. Improving access to safe water supplies for these consumers will require scalable technologies that are deployable from point-of-use (POU)/point-of-entry (POE) applications to integration with conventional-scale treatment. Simultaneously, these technologies must be affordable, robust, and sustainable, which will promote their adoption in small water systems (for example, serving≤10,000 people) with limited financial and technological resources.

Engineered nanomaterials hold vast potential for water treatment. Their high external surface area to volume ratio limits mass transfer resistances during application, making them ideal adsorbents for pollutant removal. This is in contrast to some commercial adsorbents marketed for water treatment (for example, granular activated carbon (GAC), Evoqua Water's GFH® (Granular Ferric Hydroxide media)) that possess relatively large application footprints (e.g., bed filtration) and consist primarily of internal surface area.

Iron oxides such as hematite (α-Fe₂O₃) are earth abundant, making them inexpensive and readily available for treatment applications while also minimizing risks associated with their use. Most iron oxides also have a point of zero charge near pH 7 that makes them useful as adsorbents toward both cationic and anionic targets. For example, GFH® media is a US EPA Best Available Technology (BAT) for As, while also being extensively evaluated as an adsorbent for other metals including antimony (Sb), copper (Cu), and Cr. In accordance with an exemplary embodiment, iron oxides performance could be improved by exploiting the large reactive surface area of nanomaterials, but their use is not without problems, for example, aggregation, release, and difficulty with scale-up have slowed the application of nanomaterials in water treatment.

### SUMMARY

A method is disclosed of forming core-shell iron oxide-polymer nanofiber composites, the method comprising: synthesizing composite nanofibers of polyacrylonitrile (PAN) with embedded hematite (α-Fe₂O₃) nanoparticles via a single-pot electrospinning synthesis; and

generating a core-shell nanofiber composite through a subsequent hydrothermal growth of α-Fe₂O₃ nanostructures on the composite nanofibers of polyacrylonitrile (PAN) with the embedded hematite (α-Fe₂O₃) nanoparticles.

A nanofiber composite is disclosed comprising: a core of polyacrylonitrile (PAN) with embedded hematite nanoparticles; and a shell of α-Fe₂O₃ nanostructures on the core of the polyacrylonitrile (PAN) with the embedded hematite nanoparticles.

A method is disclosed for removing heavy metal contaminations from a source of water, the method comprising: exposing a source of water to a nanofiber composite comprising: a core of polyacrylonitrile (PAN) with embedded hematite nanoparticles; and a shell of α-Fe₂O₃ nanostructures on the core of the polyacrylonitrile (PAN) with the embedded hematite nanoparticles.

### BRIEF DESCRIPTION OF DRAWINGS

FIGS. 1(a)-(c) illustrate size distribution histograms for (a) PAN, (b) composite PAN/α-Fe₂O₃, and (c) core-shell PAN/α-Fe₂O₃@α-Fe₂O₃ nanofibers, with corresponding images of the mats and SEM images of the nanofiber mats. Average nanofiber diameters and measured surface areas from BET with standard deviation are given for each material. The PAN/α-Fe₂O₃ composite shown contained 33 wt. % 10 nm α-Fe₂O₃ nanoparticles (relative to PAN) in the electrospinning sol-gel, while the core-shell PAN/α-Fe₂O₃@α-Fe₂O₃ was synthesized by hydrothermally treating this same PAN/α-Fe₂O₃ composite for 12 h in a solution of 0.14 M FeCl₃.6H₂O and L-arginine.

FIGS. 2(a)-2(b) illustrate adsorption isotherms for PAN/α-Fe₂O₃ with different mass loadings of α-Fe₂O₃ for (a) Cr(VI) and (b) Pb(II). Experiments were conducted in 10 mM MES buffer at pH of 6. Isotherms are given in terms of mass adsorbed per mass of adsorbent (mg/g), and lines are Langmuir model fits. Results demonstrate that higher loadings of α-Fe₂O₃ correspond with increased uptake of metals. PAN alone adsorbs some Pb(II) but does not adsorb any Cr(VI).

FIGS. 3(a)-3(f) illustrate adsorption isotherms for PAN/α-Fe₂O₃@α-Fe₂O₃ in blue, PAN/α-Fe₂O₃ in red, and GFH® media in green for uptake of (a, b, c) As(V) and (c, d, e) Cr(VI). Maximum adsorption capacities for 10 nm α-Fe₂O₃ nanoparticles are given by the grey lines. Experiments were conducted in batch with 5 mg of sorbent and 10 mL of 10 mM MES buffer at pH 6 with the appropriate concentration of heavy metal. Isotherms are given in terms of mass adsorbed per surface area of adsorbent (m²), mass of sorbent (g), and mass Fe in sorbent (g Fe); lines are Langmuir model fits.

FIGS. 4(a)-4(f) illustrate adsorption isotherms for PAN/α-Fe₂O₃@α-Fe₂O₃ in blue, PAN/Fe₂O₃ in red, and GFH® media in green for uptake of (a, b, c) Cu(II) and (c, d, e) Pb(II). Maximum adsorption capacities for 10 nm α-Fe₂O₃ nanoparticles are given by the grey dotted lines. Experiments were conducted in batch with 5 mg of sorbent and 10 mL of 10 mM MES buffer at pH 6 with the appropriate concentration of metal. Isotherms are given in terms of mass adsorbed per surface area of adsorbent (m²), mass of sorbent (g), and mass Fe in sorbent (g Fe); lines are Langmuir model fits.

FIG. 5 illustrates breakthrough curves for PAN/α-Fe₂O₃ (open symbols) and PAN/α-Fe₂O₃@α-Fe₂O₃ (closed symbols) for 100 ppb As(V) (with Cr(VI) present) in red, 100 ppb Cr(VI) (with As(V) present) in green, and 300 ppb Pb(II) in blue. For all filtration experiments, approximately (˜) 100 mg of material was used. Metal solutions were prepared in 10 mM MES buffer adjusted to pH 6.

FIGS. 6(a)-6(c) illustrate breakthrough curves with regeneration from flow-through filtration with PAN/α-Fe₂O₃@α-Fe₂O₃ for (a) 300 ppb Pb(II), (b) 100 ppb As(V) (with Cr(VI) present), and (c) 100 ppb Cr(VI) (with As(V) present). For Pb(II) flow-through in (a), approximately (˜) 200 mg of PAN/α-Fe₂O₃@α-Fe₂O₃ was used. After the first filtration, the filter was rinsed with clean buffer, and after the second filtration, the filter was regenerated with 0.1 M HNO₃ followed by clean buffer. For the As(V)/Cr(VI) flow-through in (b) and (c), approximately (˜) 100 mg of PAN/α-Fe₂O₃@α-Fe₂O₃ was used. After the first filtration (shown in blue), the filter was rinsed with clean buffer, and after the second filtration (shown in red), the filter was regenerated with 0.05 M NaOH followed by clean buffer. All influent solutions, with the exception of 0.05 M NaOH and 0.1 M HNO₃, were prepared in 10 mM MES buffer at pH 6.

FIGS. 7(a)-7(b) illustrate (a) Breakthrough curves from flow-through filtration with approximately (˜) 100 mg PAN/Fe₂O₃@Fe₂O₃ for Mason City groundwater (shown in green) with influent 103 ppb As and Clear Lake groundwater (shown in red) with influent 112 ppb As (with breakthrough of 100 ppb As in 10 mM MES buffer at pH 6 shown in blue for comparison). (b) Clear Lake groundwater influent and effluent, with turbidities of 22 NTU prior to filtration and 0.2 NTU after filtration, respectively. The inset shows the filter with a layer of solids after the flow-through experiment.

FIG. 8 illustrates a schematic of the dead-end filtration system used to test nanofiber filters in flow-through. As the filter holder had been modified so that it could be used for cross-flow or dead-end filtration, influent was pumped into the system on a side inlet of a Millipore 47 mm filter holder at a sufficiently high flow rate (20 mL/min) to ensure influent contact with the entire filter. Influent passed through the filter and was collected, with 5 mL samples taken periodically from the filter outlet for analysis.

FIG. 9 illustrate X-ray diffraction (XRD) spectra for (a) 10 nm α-Fe₂O₃ nanoparticles in green, (b) PAN/α-Fe₂O₃@α-Fe₂O₃ in red, and (c) PAN/α-Fe₂O₃ in blue. Peaks are consistent with d-spacings for hematite.

FIG. 10 illustrates sorption capacities for Cr(VI) for as-electrospun PAN/20 wt. % 10 nm α-Fe₂O₃ and PAN/20 wt. % 40 nm α-Fe₂O₃.

FIG. 11 illustrates XPS spectrum of the Pb 4f region for PAN/α-Fe₂O₃@α-Fe₂O₃ core-shell nanofibers after batch sorption of 60 mg/L Pb(II) in 10 mM MES at pH 6. The peaks indicate likely surface precipitation of Pb (hydr)oxides.

FIG. 12 illustrates adsorption isotherms for Cr(VI) for core-shell PAN/α-Fe₂O₃@α-Fe₂O₃ with various sizes α-Fe₂O₃ in electrospun nanofibers, wt. % of α-Fe₂O₃ in electrospun nanofibers, concentrations of hydrothermal solutions, and hydrothermal treatment durations.

FIGS. 13(a)-(d) illustrate sorption kinetics for PAN/α-Fe₂O₃@α-Fe₂O₃ in blue, PAN/α-Fe₂O₃ in red, and GFH® media in green for (a) 4.0 mg/L As(V), (b) 3.0 mg/L Cr(VI), (c) 0.6 mg/L Cu(II), and (d) 3.0 mg/L Pb(II).

FIGS. 14(a)-14(f) illustrate sorption pH edge experiments shown for 4.0 mg/L As(V) (a-c) and 3.0 mg/L Cr(VI) (d-f). Uptake (q) is given on a surface area basis (a, d), mass sorbent basis (b, e), and mass Fe basis (c, f). Speciation of metals/metalloids is given at the top, along with the typical point of zero charge (pzc) of α-Fe₂O₃. Data for GFH® media and a suspension of 10 nm hematite nanoparticles are shown for comparison, as are data for unamended PAN. At these pH values, H₂AsO₄⁻ is the dominant form below pH 6.8, above which HAsO₄²⁻ predominates. For Cr(VI), HCrO₄⁻ is the main form below pH 6.5, above which CrO₄²⁻ is the major species. Results from pH-edge experiments also imply that electrostatics is a primary driver for uptake. For example, adsorption of As(V) is expected to decrease with increasing pH due to deprotonation of H₂AsO₄⁻ to HAsO₄²⁻ at pKₐ₂ (pH=6.8) because the α-Fe₂O₃ surface is also becoming more negatively charged. Similarly, the decrease in Cr(VI) adsorption with increasing pH can be attributed to HCrO₄⁻ deprotonation to CrO₄²⁻ at pH=pKₐ₂ of 6.5.

FIGS. 15(a)-15(f) illustrate sorption pH edge experiments shown for 0.6 mg/L Cu(II) (a-c) and 3.0 mg/L Pb(II) (d-f). Uptake (q) is given on a surface area basis (a, d), mass sorbent basis (b, e), and mass Fe basis (c, f). Speciation of metals is given at the top, along with the typical point of zero charge (pzc) of Fe₂O₃. Data for GFH® media and a suspension of 10 nm hematite nanoparticles are shown for comparison, as are data for unamended PAN, which showed limited uptake in some instances (for example, mostly Pb(II)). Cu²⁺ is the dominant form of Cu(II) from pH 6 to pH 7, while Pb²⁺ predominates below pH 7.2, above which PbOH⁺ is the primary species. Once again, results imply that electrostatics is a primary driver for uptake. For example, dissolved Pb(II) species become less positively charged as pH increases from 6 to 8, transitioning from Pb²⁺ to PbOH⁺ at pH 7.2, as well as PbCO₃(aq) (from carbonate available from the atmosphere).

FIGS. 16(a)-16(b) illustrate adsorption pH edges for PAN/α-Fe₂O₃@α-Fe₂O₃ in blue and PAN/α-Fe₂O₃ in red for (a) 4.0 mg/L As(V) and (b) 3.0 mg/L Cr(VI). Open symbols and dashed lines show pH edges with the single contaminant (As(V) or Cr(VI) present), while closed symbols and solid lines show pH edges with competitive sorption (As(V) and Cr(VI) both present). Experiments were conducted in batch with 5 mg of sorbent and 10 mL of 10 mM MES buffer for pH 6 and 6.5 and 10 mM HEPES buffer for pH 7 and 8. pH edges are given in terms of mass adsorbed per surface area of adsorbent.

FIGS. 17(a)-17(d) illustrate sorption pH edges for PAN/α-Fe₂O₃@α-Fe₂O₃ in blue and PAN/Fe₂O₃ in red for (a) 0.6 mg/L Cu(II), (b) 3.0 mg/L Pb(II) and (c) 4.0 mg/L As(V), (d) 0.6 mg/L Cu(II). Open symbols and dashed lines show pH edges with the single contaminant, while closed symbols and solid lines show pH edges with competitive sorption. Experiments were conducted in batch with 5 mg of sorbent and 10 mL of 10 mM MES buffer for pH 6 and 6.5 and 10 mM HEPES buffer for pH 7. pH edges are given in terms of mass adsorbed per surface area of adsorbent.

FIG. 18 is Table 1, which illustrates water qualities in accordance with an exemplary embodiment.

FIG. 19 is Table 2, which illustrates Langmuir model fit parameters in accordance with an exemplary embodiment.

### DETAILED DESCRIPTION

Point-of-use water treatment technologies can help mitigate risks from drinking water contamination, particularly for metals (and metalloids) that originate in distribution systems (for example, chromium, lead, copper) or are naturally occurring in private groundwater wells (for example, arsenic).

In accordance with an exemplary embodiment, composite nanofibers of polyacrylonitrile (PAN) with embedded hematite (α-Fe₂O₃) nanoparticles were synthesized via a single-pot electrospinning synthesis. A core-shell nanofiber composite was also prepared through the subsequent hydrothermal growth of α-Fe₂O₃ nanostructures on embedded hematite composites. In accordance with an exemplary embodiment, properties of embedded hematite composites were controlled using electrospinning synthesis variables (for example, size and loading of embedded α-Fe₂O₃ nanoparticles), whereas core-shell composites were also tailored via hydrothermal treatment conditions (for example, soluble iron concentration and duration). Although uptake of Cu(II), Pb(II), Cr(VI), and As(V) was largely invariant across the core-shell variables explored, metal uptake on embedded nanofibers increased with α-Fe₂O₃ loading. Both materials exhibited maximum surface-area-normalized sorption capacities that were comparable to α-Fe₂O₃ nanoparticle dispersions and exceeded that of commercial iron oxide based sorbents. Further, both types of composite exhibited strong performance across a range of environmentally relevant pH values (6.0 to 8,0).

In accordance with an exemplary embodiment, while metal uptake was roughly comparable between the embedded and core-shell composites in equilibrium batch experiments, core-shell structures, with a majority of surface α-Fe₂O₃, exhibited superior performance in dead-end microfiltration systems, where metal/metalloid uptake is likely kinetically limited. Core-shell nanofiber based filters also retained much of the durability and flexibility exhibited by embedded nanofibers. Additional tests with authentic groundwater samples demonstrated the ability of the core-shell nanofiber filters to remove simultaneously both heavy metals and suspended solids, illustrating their promise as a nano-enabled technology for point-of-use water treatment.

In accordance with an exemplary embodiment, electrospinning can be used as a scalable and industrially viable route for single-pot synthesis of composite nanofibers, to produce various polyacrylonitrile (PAN)/hematite (α-Fe₂O₃) composites for use as reactive filtration media (for example, simultaneous particle removal and metal sequestration). In accordance with another exemplary embodiment, subsequent hydrothermal treatment to further process these more traditional composites into novel PAN/α-Fe₂O₃ core-shell nanofibers is disclosed. Composite properties from microscopy and surface area analysis were then correlated with their uptake of Cu, Pb, Cr, and As across a range of metal and metalloid (hereafter simply “metal”) concentrations and mixtures, as well as pH values. Ultimately, the performance of traditional (for example, nanoparticle embedded) and core-shell nanofiber composites was compared and benchmarked versus commercially available GFH® media to establish potential benefits of reactive filtration technologies using high surface area nanofiber networks.

Beyond batch performance studies, practical considerations were addressed for the application of nanofiber composites in water treatment. Material strength testing was conducted to assess the robustness and durability of these nanofiber networks. Pure inorganic (for example, iron oxide) nanofibers, for example, are often brittle and lack the material strength to make them feasible in treatment applications. More recently, while cohesive iron oxide-polymer composites have been fabricated, demonstrations of their reactivity have been limited to highly idealized systems (for example, targeting dye removal) that provide little insight into their performance toward higher priority pollutant targets (e.g., metals). Accordingly, to ensure that optimal composite formulations exhibit both high reactivity and material strength, nanoparticle-embedded and core-shell nanofiber composites were tested in a dynamic flow-through system. These flow-through tests, which included trials with authentic groundwater samples from As contaminated groundwater wells, allowed for monitor simultaneous removal of As and suspended particles under conditions most representative of treatment applications.

### EXPERIMENTAL METHODS

Reagents. All chemicals were reagent grade or better and used as received. A detailed list of reagents is provided in the Supplemental Information (SI).

Nanofiber filter synthesis. Electrospun PAN nanofibers with embedded α-Fe₂O₃ nanoparticles (hereafter PAN/Fe₂O₃) were prepared by electrospinning a PAN precursor solution containing either 10 nm or 40 nm α-Fe₂O₃ nanoparticles that were synthesized.

To generate core-shell composites (hereafter PAN/Fe₂O₃@Fe₂O₃), PAN/Fe₂O₃ nanofibers were hydrothermally treated. A piece of PAN/Fe₂O₃ mat (approximately (˜) 6 cm×10 cm) was placed in a 150 mL equimolar solution (up to 0.14 M) of FeCl₃.6H₂O and L-arginine held in a plastic container that was then loosely covered and heated at 95° C. for up to 12 hours (h). After treatment, mats were rinsed with deionized (DI) water, 0.1 M HCl, and 0.1 M NaOH, and then sonicated in DI water for 1.5 h to ensure the removal of extraneous material not firmly affixed to the surface.

Nanofiber filter characterization. All materials were characterized using scanning electron microscopy (SEM) for their size and morphology, X-ray diffraction (XRD) for their crystal phase, N₂-BET analysis for specific surface area, acid digestion for total iron analysis, X-ray photoelectron spectroscopy (XPS) for surface composition, and mechanical testing for material strength. Details of these characterization approaches are given in the SI.

Batch sorption experiments. Experiments with As(V), Cr(VI), and Cu(II) were conducted in 20 mL glass vials sealed with butyl rubber septa, while those with Pb(II) were conducted in 15 mL plastic centrifuge tubes to avoid sorption on glass. Approximately 5 mg of nanofibers (approximately (˜) 0.5 cm×0.5 cm piece) was placed in 10 mL of appropriate buffer solution (10 mM MES or HEPES). Isotherm, kinetics, and pH edge batch experiments were then initiated by spiking these solutions with As(V), Cr(VI), Cu(II), and Pb(II). For isotherm experiments, reactors were spiked with metal concentrations ranging from 0.3 mg/L to 200 mg/L using potassium chromate, sodium arsenate dibasic heptahydrate, copper chloride dihydrate, and lead nitrate. Isotherm experiments were conducted at pH 6 to help ensure metal solubility. For pH edge experiments, solutions of either 10 mM MES (for pH 6 and 6.5) or HEPES (for pH 7 and 8) were spiked with 4 mg/L As(V), 3 mg/L Cr(VI), 3 mg/L Pb(II), or 0.6 mg/L Cu(II). The markedly lower Cu(II) concentration was to help ensure complete solubility at each pH considered, although Cu(II) experiments were not conducted at pH 8 due to its solubility constraints. Kinetic experiments examining the rate of metal uptake were also carried out at these initial concentrations at pH 6. Interspecies competitive sorption was examined with mixtures of two metals at the initial concentrations and pH values considered in pH edge experiments.

After assembly, vials were placed on a rotator (Cole-Parmer Roto-Torque) for up to 24 hours (h). For dissolved metal analysis, 5 mL samples were withdrawn from the reactors, acidified to 2% HNO₃, filtered with 0.45 μm nylon filters, and analyzed by inductively coupled plasma optical emission spectrometry (ICP-OES; details below). Sorbed masses of metals were quantified from the difference between their initial and equilibrium dissolved concentration. For all experiments, controls were completed with buffer and metal in the absence of any sorbent material; sorption of As(V), Cr(VI), and Cu(II) on the glass vials and rubber septa and Pb(II) on the plastic tubes was negligible.

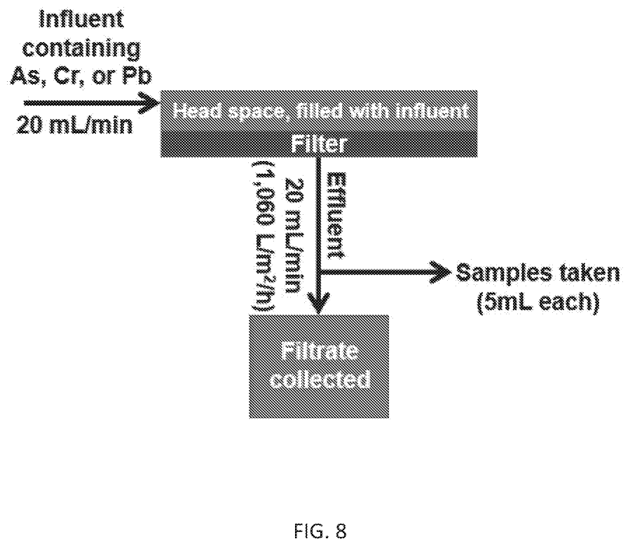

Simulated point-of-use treatment in flow-through filtration systems. For flow-through filtration experiments (FIG. 8), nanofiber mats were cut to a 47 mm diameter and placed in a filter holder (Millipore) connected to a peristaltic pump (Masterflex). Buffer solutions at pH 6 containing either 100 ppb As(V) and Cr(VI) or 300 ppb Pb(II) were pumped through the system with a flux of 1,060 L/m²/h, as determined gravimetrically. During operation, 5 mL samples were collected every 5 minutes, acidified, and filtered for analysis. Reversibility and regeneration of the filters in flow-through was examined by subsequently passing either 2 L of 10 mM MES buffer at pH 6, a combination of 1 L of 0.05 M NaOH followed by 1 L of pH 6 10 mM MES (for As, Cr experiments), or a combination of 1 L of 0.1 M HNO₃ followed by 1 L of pH 6 10 mM MES (for Pb experiments) across the filter. Previously, alkaline and acid regeneration of iron oxides for sorption of the respective metals has been effective.

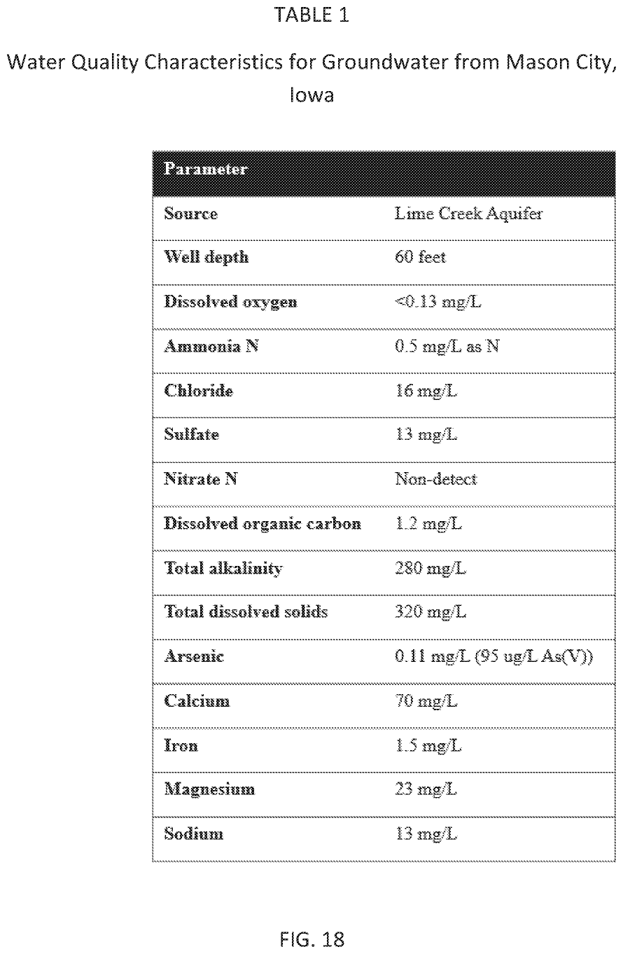

Nanofiber filters were also tested in flow-through filtration experiments with authentic groundwater samples containing As collected from private wells in Mason City and Clear Lake, Iowa. The raw groundwater from both locations had turbidity of 22 NTU, pH of 8.5, and As concentrations ranging from 100 ppb to 120 ppb. Additional groundwater quality characteristics are provided in Table 1 (FIG. 18).

Dissolved metals analysis. The ICP-OES (PerkinElmer Optima 7000 DV) was calibrated with standards for As(V), Cu(II), Cr(VI), and Pb(II) preceding sample analysis. A limited number of Cr(VI) samples were also analyzed colorimetrically using the diphenylcarbazide method.

### RESULTS AND DISCUSSION

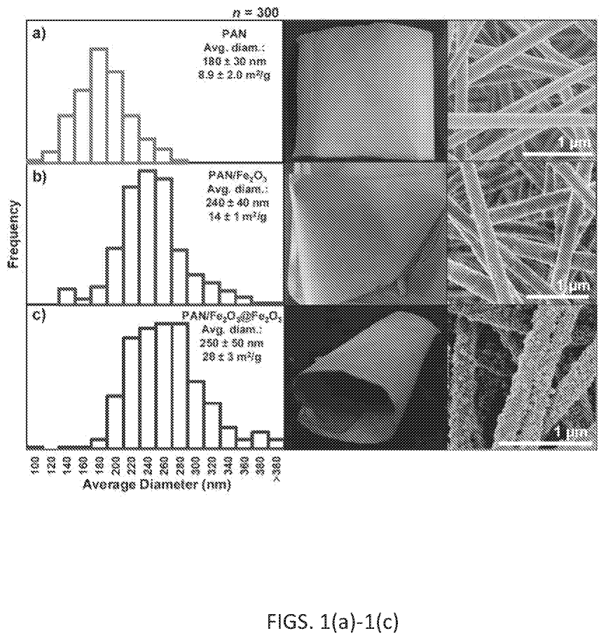

Nanofiber characterization and material strength testing. FIGS. 1(a)-1(c) shows SEM images, nanofiber diameter distributions, and specific surface areas for unamended PAN, the embedded PAN/Fe₂O₃ composite, and the hydrothermally treated core-shell PAN/Fe₂O₃@Fe₂O₃.

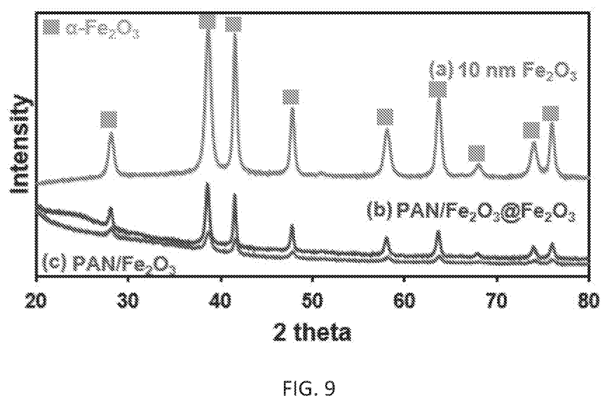

XRD confirmed that the phase of nanoparticles embedded in PAN remained as α-Fe₂O₃ throughout synthesis, while the hydrothermal coating on PAN/Fe₂O₃ was also α-Fe₂O₃ (FIG. 9). Further, histograms of nanofiber diameters revealed that the inclusion of Fe₂O₃ (shown at 33 wt. % of 10 nm particles relative to PAN) caused the average nanofiber diameter to increase from 180 (±30) nm to 240 (±40) nm. Although hydrothermal treatment resulted in growth of particulate nanostructures on the surface of PAN/Fe₂O₃ nanofibers, PAN/Fe₂O₃@Fe₂O₃ materials did not exhibit any significant increase in average diameter (250 (±50) nm). Also, the thickness of all mats was relatively consistent at approximately (˜) 0.5 mm, as determined with SEM. From acid digestion, both the embedded- and the core-shell composites contained less total iron (approximately (˜) 20% and 50% total Fe by mass, respectively) than commercial GFH® media, with approximately (˜) 20% and 50% total Fe by mass, respectively. For comparison, GFH® media consists of (approximately (˜) 70% Fe by mass).

Despite possessing larger average diameters, α-Fe₂O₃-containing composites exhibit greater specific surface area than unmodified PAN, which can be attributed to the high surface area of the 10 nm α-Fe₂O₃ particles (approximately (˜) 80 m²/g) integrated into the PAN, which impart some degree of surface roughness to the nanofiber mat based on SEM images. However, variations in the mass loading of α-Fe₂O₃ nanoparticles in PAN (from 8 wt. % to 50 wt. % relative to PAN) did not impact composite specific surface area. In contrast, the extensive growth of nanostructures on the surface of core-shell composites increased specific surface area by two-fold, from approximately (˜) 15 m²/g for PAN/Fe₂O₃ to approximately (˜) 30 m²/g for PAN/Fe₂O₃@Fe₂O₃.

Notably, hydrothermal treatment of PAN/Fe₂O₃ did not eliminate the flexibility or wettability of the mat despite extensive surface coating with α-Fe₂O₃. Mats could be bent and rolled (FIGS. 1(a)-1(c)), which should help facilitate their application in reactor platforms that optimize their performance (e.g., spiral-wound membrane filters). Failure loads for PAN/Fe₂O₃, and PAN/Fe₂O₃@Fe₂O₃ were statistically equivalent at 0.26 (±0.06) and 0.22 (±0.03) N, respectively (values represent mean and standard deviations of at least n=3 measurements), but these values were significantly less (p<0.0358) than that measured for unamended PAN (0.40 (±0.10) N). In accordance with an exemplary embodiment, at 33 wt. % α-Fe₂O₃, the embedded nanoparticles and nanoparticle aggregates likely serve as areas that concentrate stress and cause failure at lower loads relative to unamended PAN, as has been reported elsewhere. Further, inclusion of α-Fe₂O₃ nanoparticles produced wider nanofibers, and the Young's modulus of electrospun nanofibers has often been found to increase with decreasing diameter because the level of molecular orientation in the nanofibers increases.

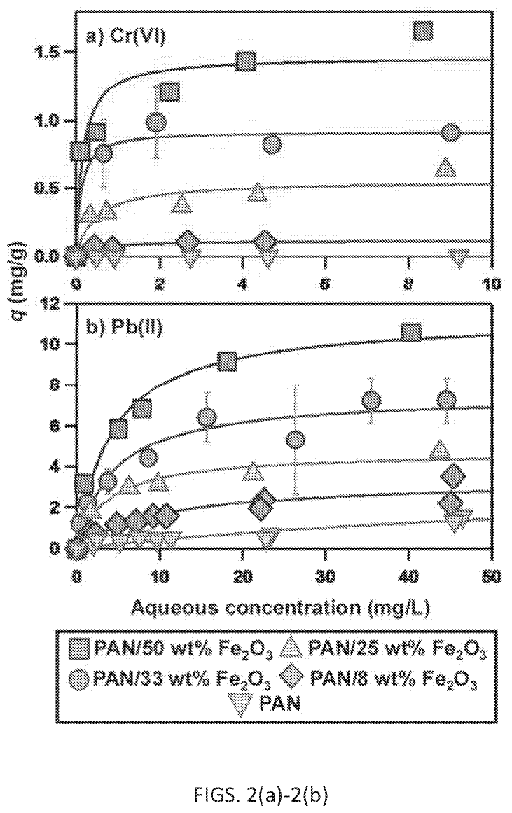

Optimization of PAN/Fe₂O₃ embedded composites for metal uptake. For all nanofiber sorbents, equilibrium was typically achieved after 12 h and adsorption isotherms (FIGS. 2(a)-4(f) were best described by the Langmuir model (Eq. 1).

$$q = \frac{{K}_{L} {q}_{max} {C}_{e}}{1 + {K}_{L} {C}_{e}} \qquad ( 1 )$$

In Eq. 1 q is the mass of contaminant adsorbed per unit mass or specific surface area of adsorbent (mg/g or mg/m²); K_{L} is the Langmuir coefficient (L/mg); qₘₐₓ is the amount of adsorption at one monolayer (mg/g or mg/m²); and Cₑ is the concentration of the contaminant in solution at equilibrium (mg/L). Although the Langmuir model assumes reversible uptake, it was noted that sorption on nanofiber proved only partially reversible (as described below).

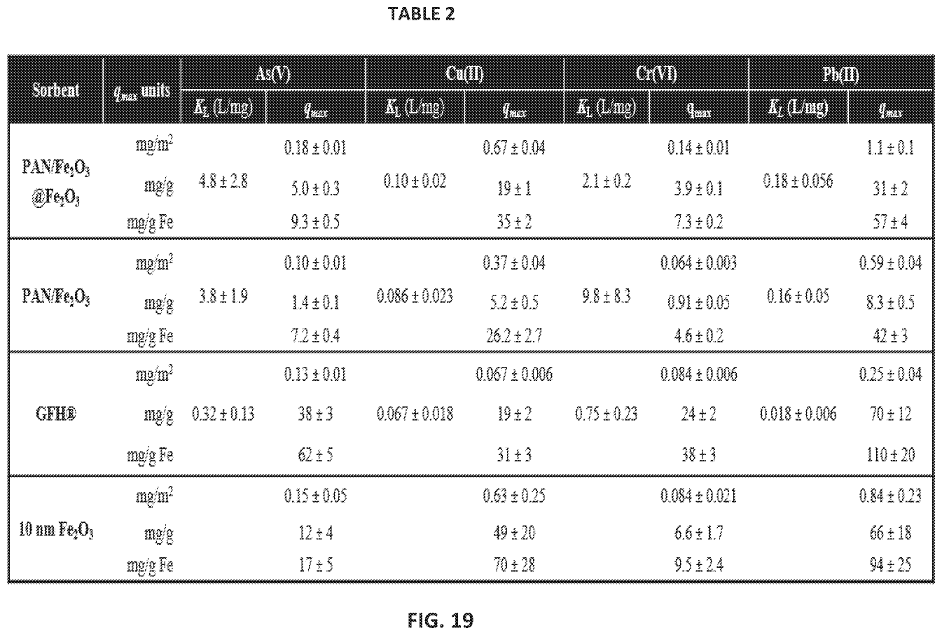

Langmuir model fit parameters (i.e., K_{L} and qₘₐₓ values) are summarized in Table 2 (FIG. 19), and the best-fit isotherms are shown in corresponding figures (as solid lines). These Langmuir model fit parameters were used as a basis for comparing and optimizing material performance. A priority was initially placed on maximizing material capacity, thus qₘₐₓ values (both per unit mass and surface area of sorbent) were the focus of early nanofiber optimization efforts.

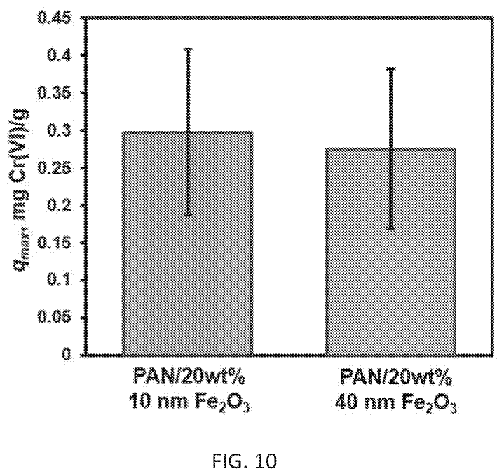

For PAN/Fe₂O₃ nanofibers, how the primary particle size of the embedded α-Fe₂O₃ nanoparticles influenced uptake of Cr(VI) (FIG. 10). PAN containing 20 wt. % of either 10 nm or 40 nm α-Fe₂O₃ exhibited identical sorption capacities (qₘₐₓ approximately (˜) 0.3 mg Cr(VI)/g) was first evaluated. Although 10 nm α-Fe₂O₃ exhibits greater specific surface area than 40 nm α-Fe₂O₃, it is prone to aggregate more extensively. This, in turn, could limit the amount of α-Fe₂O₃ available at the surface of PAN/Fe₂O₃ composites and cause comparable reactivity regardless of α-Fe₂O₃ primary particle size.

Related to nanoparticle inclusion, uptake of Cr(VI) and Pb(II) on unamended PAN nanofibers and the influence of α-Fe₂O₃ nanoparticle loading (up to 50 wt. % as 10 nm α-Fe₂O₃) was initially assessed at pH 6 (FIG. 2). Without α-Fe₂O₃, PAN nanofibers demonstrated limited sorption of Pb(II) but did not sorb any Cr(VI). This Pb(II) uptake is likely from the electron rich nitrile (—C≡N) groups of PAN, which may represent a viable complexation site for cationic metal targets. Increasing α-Fe₂O₃ loading increased metal uptake. Values of qₘₐₓ increased from 0.1 (±0.01) to 1.5 (±0.1) mg/g for Cr(VI) and from 3 (±0.5) to 11 (±1) mg/g for Pb(II) across the α-Fe₂O₃ loadings considered (8-50 wt. % relative to PAN) (FIG. 2). Thus, evidence suggests that α-Fe₂O₃ exposed at the composite-water interface represents the dominant sorbent in embedded composite systems, with the amount of near-surface α-Fe₂O₃ scaling proportionally with the bulk α-Fe₂O₃ content.

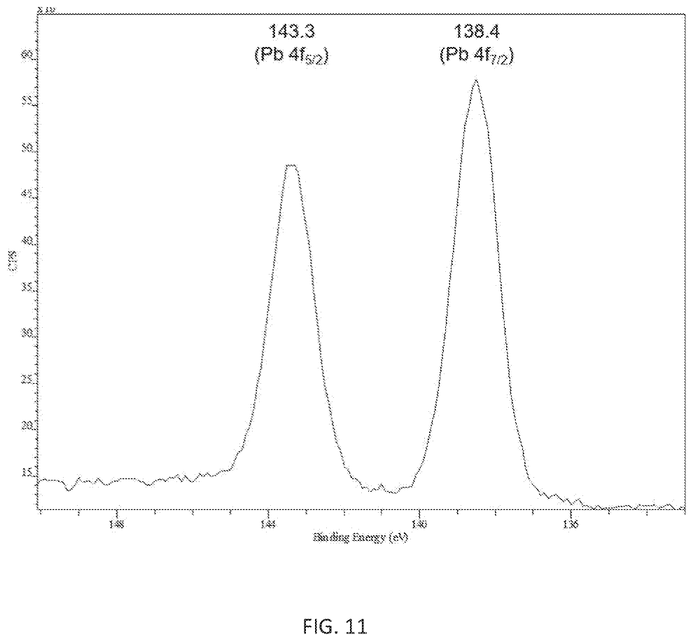

Increasing α-Fe₂O₃ loading also improved the affinity of PAN/Fe₂O₃ for Cr(VI), with K_{L} values increasing for Cr(VI) from 2 (±1) to 6 (±3) L/mg with 8 wt. % to 50 wt. % α-Fe₂O₃. Cr(VI) forms both inner-sphere monodentate and bidentate complexes and outer-sphere complexes on α α-Fe₂O₃. Greater Cr(VI) affinity with higher α-Fe₂O₃ loadings may reflect not only increased access to surface Fe sites but also the influence of the PAN support on the activity of these sites. In contrast, K_{L} values were relatively constant for Pb(II) (from 0.1-0.2 L/mg), suggesting a consistent affinity for Pb(II) even though the number of sorption sites increases. Pb(II) commonly forms bidentate complexes with O sites on α-Fe₂O₃, but can also precipitate on iron oxide surfaces in (hydr)oxide forms, especially at elevated Pb(II) concentrations. Unfortunately, the Pb(II) loading on the PAN/Fe₂O₃ surface was not high enough to detect and characterize via methods including XRD or XPS (notably, as discussed later, XPS suggests Pb precipitates on core-shell PAN/Fe₂O₃@Fe₂O₃; see FIG. 11).

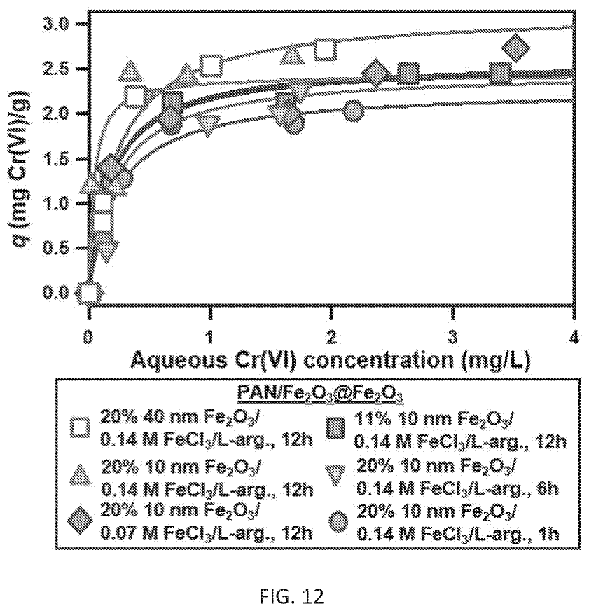

Optimization of PAN/Fe₂O₃@Fe₂O₃ core-shell structures for metal uptake. Core-shell PAN/Fe₂O₃@Fe₂O₃ nanofibers synthesized with various α-Fe₂O₃ primary particle sizes (10 and 40 nm) and loadings (20 wt. % to 33 wt. %), hydrothermal solution concentrations (0.07 M to 0.14 M FeCl₃.6H₂O and L-arginine), and hydrothermal treatment times (1-12 h) were effectively comparable in performance, as assessed by Cr(VI) sorption isotherms (FIG. 12). In accordance with an exemplary embodiment, their consistent performance was attributed to the relatively high loading of embedded α-Fe₂O₃ nanoparticles, which provides an abundance of nucleation sites on the PAN surface for the hydrothermal deposition and growth of the α-Fe₂O₃ nanostructured shell. This, in turn, produces external surface area for Cr(VI) uptake that is essentially invariant across the synthesis conditions explored.

In accordance with another exemplary embodiment, core-shell composites from PAN/Fe₂O₃ nanofibers with narrower diameters were also developed. These core-shell composites were prepared by first electrospinning PAN/33 wt. % α-Fe₂O₃ at low relative humidity (approximately (˜) 10% RH) and subsequently coating these composites hydrothermally with Fe₂O₃. This produced core-shell nanofibers with an average diameter of 160±40 nm, roughly 100 nm less than those shown in FIGS. 1(a)-1(c). Nevertheless, the qₘₐₓ value for Cr(VI) did not increase on these narrower diameter materials, which may suggest that any gains in reactive surface area obtained by decreasing nanofiber diameter are negligible relative to the surface area increase afforded by the nanostructured α-Fe₂O₃ coating grown hydrothermally.

Performance comparison of PAN/Fe₂O₃ and PAN/Fe₂O₃@Fe₂O₃ to traditional iron oxide sorbents.

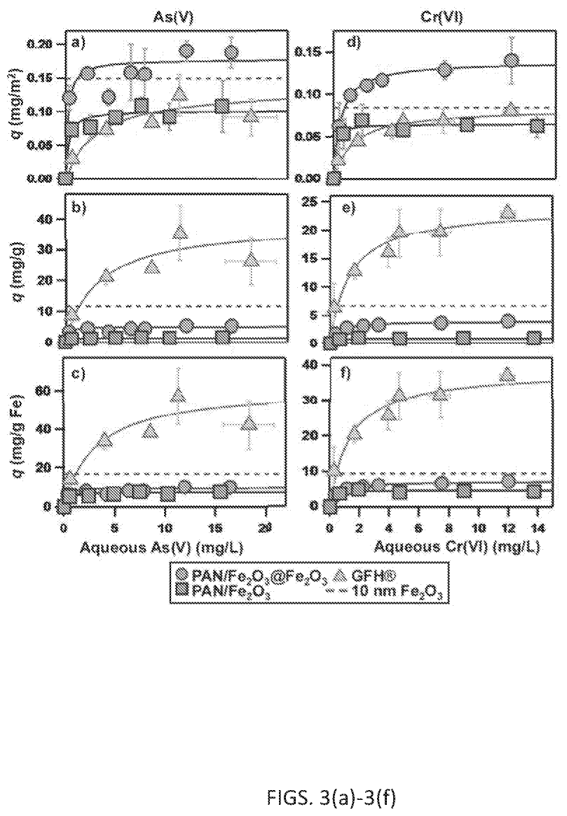

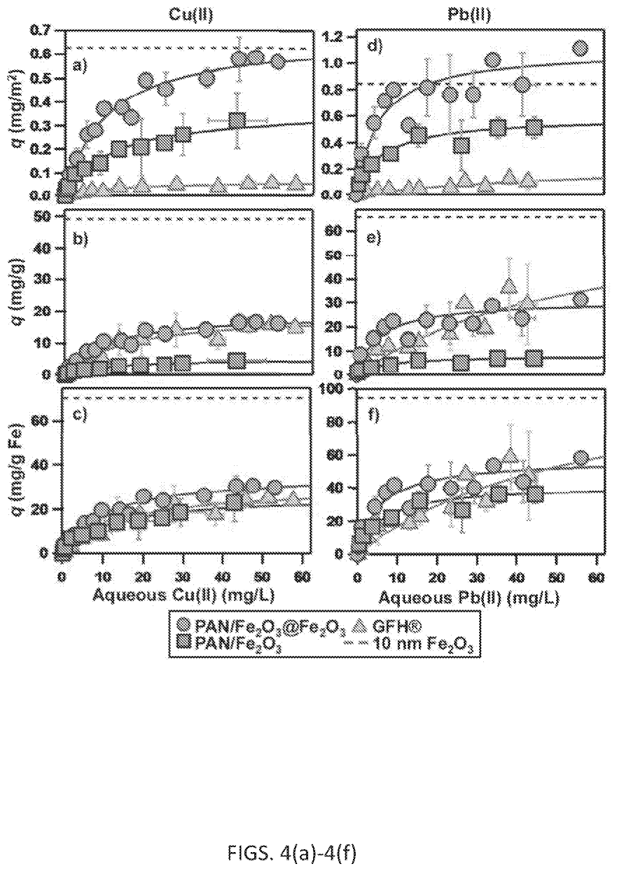

Sorption isotherms. Adsorption isotherms for anionic As(V) and Cr(VI) (FIGS. 3(a)-3(f)) and cationic Cu(II) and Pb(II) (FIGS. 4(a)-4(f) were collected at pH 6 for PAN/Fe₂O₃ (33 wt. % of Fe₂O₃ relative to PAN), PAN/Fe₂O₃@Fe₂O₃, and GFH® media. At pH 6, the predominant form of each metal is H₂AsO₄⁻, HCrO₄⁻, Cu²⁺, and Pb²⁺.

Across all metals considered, PAN/Fe₂O₃@Fe₂O₃ outperformed PAN/Fe₂O₃ and commercial GFH® media on the basis of available surface area (often by approximately (˜) 2-fold), and achieved surface-area-normalized sorption capacities equivalent to dispersions of 10 nm α-Fe₂O₃ nanoparticles. In accordance with an exemplary embodiment, it was anticipated that GFH® media, which consists of poorly crystalline akaganeite (β-FeOOH), would better adsorb anions than cations at near-neutral pH because it is widely marketed for As removal. Indeed, on a per mass basis (either of total sorbent mass or available Fe mass), GFH® media was by far the most effective sorbent for oxyanions As(V) and Cr(VI). In contrast, PAN/Fe₂O₃@Fe₂O₃ and 10 nm Fe₂O₃ nanoparticles generally exhibited greater sorption capacities for cations (for example, Cu(II) and Pb(II)) than anions (for example, As(V) and Cr(VI)) (Table 2—FIG. 19), and achieved in mass-normalized uptake capacities for cations that were essentially equivalent to GFH® media. This behavior is consistent with both nanoparticle suspensions and composite nanofibers possessing lower points of zero charge (pzc) than GFH® media.

For the composite materials, reactivity was compared with that of the components from which they were assembled. As one line of comparison, the relative qₘₐₓ values for Cr(VI), As(V), Cu(II), and Pb(II) at pH 6 are 1.0:1.8:7.5:10 for the 1.0 nm α-Fe₂O₃ suspension. This trend reasonably matches that observed for PAN/Fe₂O₃ (1.0:1.7:5.8:9.2), indicating that embedding α-Fe₂O₃ nanoparticles in PAN has little influence on their surface chemistry for binding metals. For PAN/Fe₂O₃@Fe₂O₃, although the same qualitative trend was observed, quantitative differences (1:1.3:4.8:7.9) indicate slight differences in the types and abundance of surface sites on the α-Fe₂O₃ coating on core-shell nanofibers.

For all sorbents, trends in metal uptake match prior reports for this metal suite [As(V), Cr(VI), Cu(II), and Pb(II)] on α-Fe₂O₃. Thus, established mechanisms for metal uptake on α-Fe₂O₃ (e.g., surface complexation) are likely at play in all sorbent systems. Accordingly, the performance of α-Fe₂O₃ nanofiber composites can likely be estimated from the extensive body of work that exists for nanoparticulate Fe₂O₃ sorbents. Further, XPS suggests with elevated concentrations of Pb(II) (i.e., 60 mg/L) (FIG. 11), the metal precipitates on core-shell PAN/Fe₂O₃@Fe₂O₃, which has been shown previously with PAN/iron oxide composites.

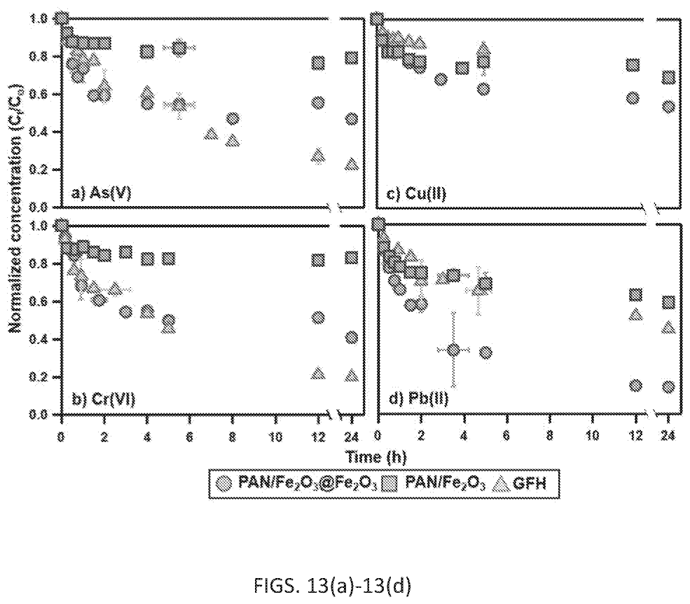

Uptake rates. In all systems, a short interval of rapid uptake (typically in the first hour or less) was followed by a period of slower sorption until equilibrium was achieved (FIGS. 13(a) and 13(b)). Notably, the rate of initially rapid uptake on PAN/Fe₂O₃@Fe₂O₃ and PAN/Fe₂O₃ were roughly equivalent for all metals, and these values were generally comparable to or greater than those observed for GFH® media. Equilibrium uptake of oxyanions [As(V) and Cr(VI)] on PAN/Fe₂O₃ was achieved after approximately (˜) 1 h, while equilibrium in PAN/Fe₂O₃@Fe₂O₃ systems was reached after approximately (˜) 2 h, For uptake of cations [Cu(II) and Pb(II)], PAN/Fe₂O₃ was first to achieve equilibrium after approximately (˜) 2 h, whereas PAN/Fe₂O₃@Fe₂O₃ reached equilibrium after 5 h for Cu(II) and between 5 and 12 h for Pb(II) (FIGS. 13(c) and 13(d)). In comparison, GFH® media had reached approximately (˜) 50% uptake of all metals within 2 to 4 hours, and equilibrium was typically attained over 12 to 24 hours.

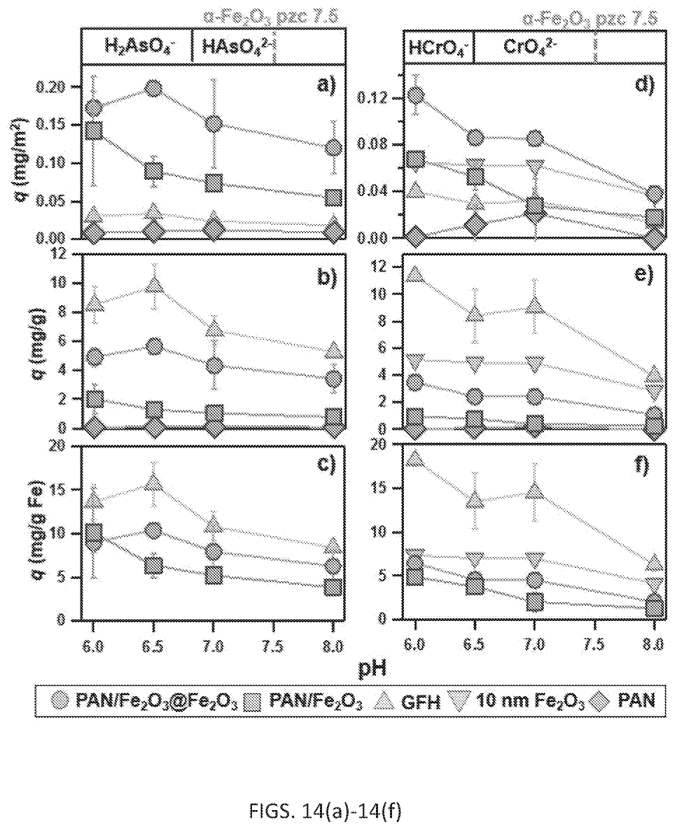

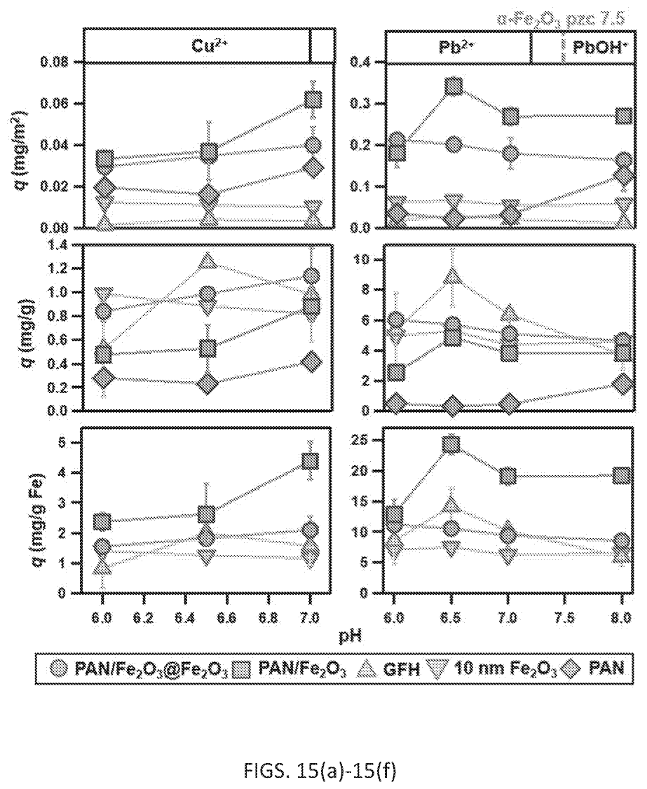

pH edge. pH-dependent sorption was assessed from pH 6 to 8 at relatively low initial concentrations compared to those used in isotherms [4 As(V), 3 mg/L Cr(VI), 0.6 mg/L Cu(II), and 3 mg/L Pb(II)]. These results are shown in FIGS. 13(a)-13(d); FIGS. 14(a)-14(f) for oxyanions and FIGS. 15(a)-15(f) for cations, along with predominance diagrams for each metal over this pH range.

For anionic As(V) and Cr(VI), sorption generally decreased with increasing pH on PAN/Fe₂O₃, PAN/Fe₂O₃@Fe₂O₃, and GFH® media, consistent with expectations from prior reports with hematite and that electrostatic contributes to metal uptake (i.e., anion uptake diminishes as the hematite surface grows more negatively charged at higher pH). As with isotherms, PAN/Fe₂O₃@Fe₂O₃ bound the most As(V) per unit surface area, and also exhibited greater capacity than PAN/Fe₂O₃ when sorbed As(V) concentrations were normalized by total sorbent mass and the mass of available Fe. In contrast, GFH® media exhibited the most uptake per unit sorbent and Fe mass.

For uptake of cationic Cu(II) and Pb(II), the two types of composite nanofibers resulted in the greatest metal uptake across all pH values, both for adsorption per unit surface area and on the basis of total sorbent mass and available Fe. A notable difference from observed performance trends with for oxyanions uptake was that at the metal concentrations used in pH-edge experiments (lower than those in isotherms), PAN/Fe₂O₃ adsorbed comparable or more metal cations per unit surface area than PAN/Fe₂O₃@Fe₂O₃.

There were also differences in performance of the materials toward each cation. For Cu(II), sorption increased modestly on all sorbents (but typically by no more than two-fold) from pH 6 to pH 7. This behavior is once again consistent with that typically observed for cation binding on more traditional iron oxide sorbents. Pb(II) uptake as a function of pH varied across the different materials. Pb(II) uptake was relatively low on PAN from pH 6 to 7 but increased nearly four-fold at pH 8 to surface-area normalized Pb(II) concentrations that rivaled nanofiber composites. In contrast, sorption of Pb(II) on PAN/Fe₂O₃@Fe₂O₃ decreased monotonically, albeit only slightly, from pH 6 to 8. PAN/Fe₂O₃ exhibited a maximum in Pb(II) uptake at pH 6.5, behavior that was also observed for GFH® media. Notably for Pb(II), a clear increase in adsorption is often reported with increasing pH on iron oxides, behavior that was not pronounced on our composites. Again, this may relate to the ability of PAN functionalities to influence Pb(II) binding, particularly at higher pH values.

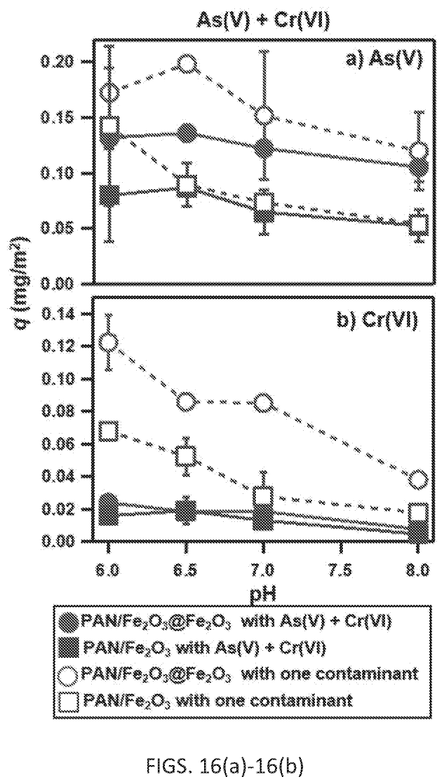

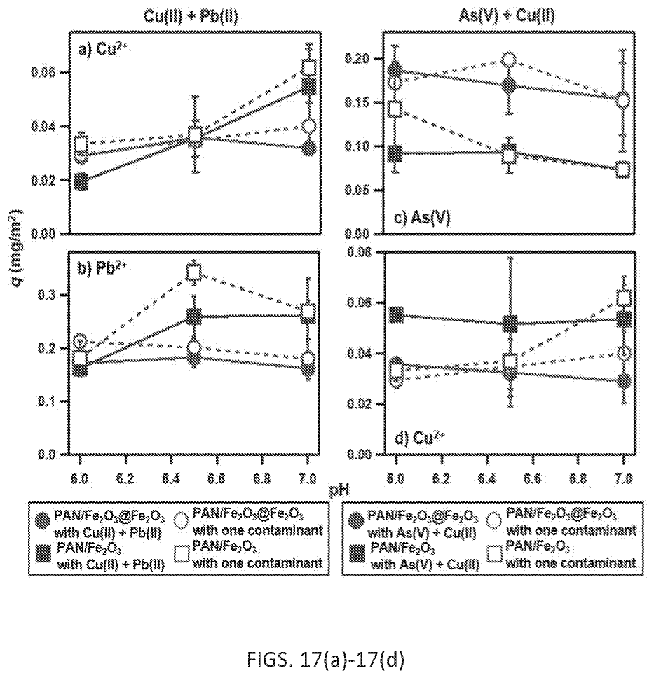

Competitive sorption. In mixtures of As(V) and Cr(VI), sorption of As(V) was largely unaffected (FIG. 16(a)) but uptake of Cr(VI) was inhibited considerably for all materials and pH values (FIG. 16(b)). For PAN/Fe₂O₃, uptake generally decreased three- to four-fold, which was comparable to the extent of inhibition observed in suspensions of 10 nm α-Fe₂O₃. PAN/Fe₂O₃@Fe₂O₃ exhibited five-fold less uptake of Cr(VI) in the presence of As(V). This behavior was anticipated, as previous studies have shown As(V) and Cr(VI) to compete directly for surface sites on iron oxide, with As(V) prevailing in equilibrium systems. Neither mixtures of As(V) and Cu(II) (oxyanion-cation) nor Cu(II) and Pb(II) (cation-cation) resulted in inhibition, as discussed hereinafter (FIGS. 17(a)-17(d)), suggesting reasonable versatility for composite materials when applied to mixed metal systems.

### Reactive Filtration Studies With Model and Authentic Groundwater

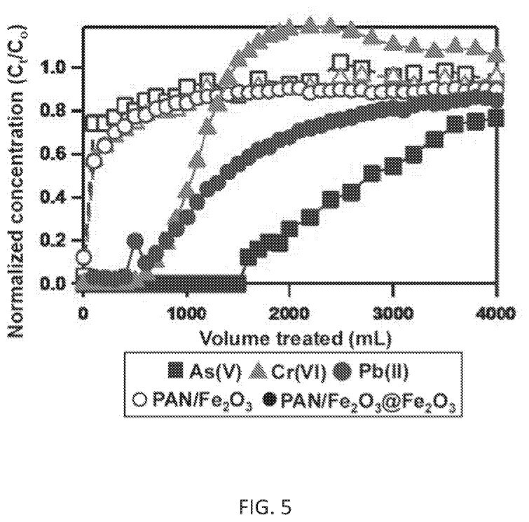

Filtration in model water systems. A filter consisting of 100 mg of PAN/Fe₂O₃ (1.4 m² available surface area) was evaluated at pH 6 (with 10 mM MES buffer) against an influent of 100 ppb As(V) (i.e., 10 times the EPA MCL) and 100 ppb Cr(VI) (i.e., equal to the EPA MCL). Both As(V) and Cr(VI) were immediately detectable in effluent, with effluent concentrations approximately (˜) 80% and 60% of influent, respectively, after the first 100 mL, of water treated (FIG. 5). Similarly, upon exposure to 300 ppb Pb(II) (i.e., 20 times the EPA action level), Pb(II) was detected at approximately (˜) 60% of influent within the first 100 mL.

Comparable evaluation of a 100 mg filter (2.8 m² available surface area) of core-shell PAN/Fe₂O₃@Fe₂O₃ was at pH 6 exhibited significantly better metal removal; As(V) remained below detection limits (approximately (˜) 10 μg As/L) the first 1,500 mL treated, Cr(VI) remained below detection limits (approximately (˜) 6 μg Cr/L) for the first 700 mL, and Pb(II) exceeded detection limits (approximately (˜) 10 μg Pb/L) after 400 mL (FIG. 5). Thus, despite the comparable performance of composites in closed batch systems, the external α-Fe₂O₃ shell on PAN/Fe₂O₃@Fe₂O₃ appears markedly better for application in flow-through systems, where metal removal must occur short contact times (estimated <1 s for filter systems presented herein).

Unexpectedly, As(V) did not adversely impact uptake of Cr(VI) in flow-through, as breakthrough curves for solutions with only Cr(VI) were comparable to that observed with an oxyanion mixed influent (FIG. 5). This is another deviation from our results in batch systems, and it was assumed that conditions in these flow-through systems do not allow sufficient time for As(V) to displace Cr(VI) from available binding sites (i.e., sorption in these filters is kinetically, rather than thermodynamically, controlled). Notably, the levels of sorption achieved after exposure to 4 L of 100 ppb As/100 ppb Cr mixed influent (i.e., 2.9 mg As(V)/g and 0.7 mg Cr(VI)/g) were lower, for Cr(VI) considerably, than the sorption capacities measured in batch isotherms (5.0 and 3.9 mg/g, respectively). Further, while effluent As(V) did not ever reach influent concentration during the 4 L experiment, effluent Cr(VI) matched influent concentrations after treatment of 1,500 mL. Thus, it appears that a large number of sites responsible for Cr(VI) sorption at equilibrium (i.e., in batch) were inaccessible in the kinetically limited flow through system.

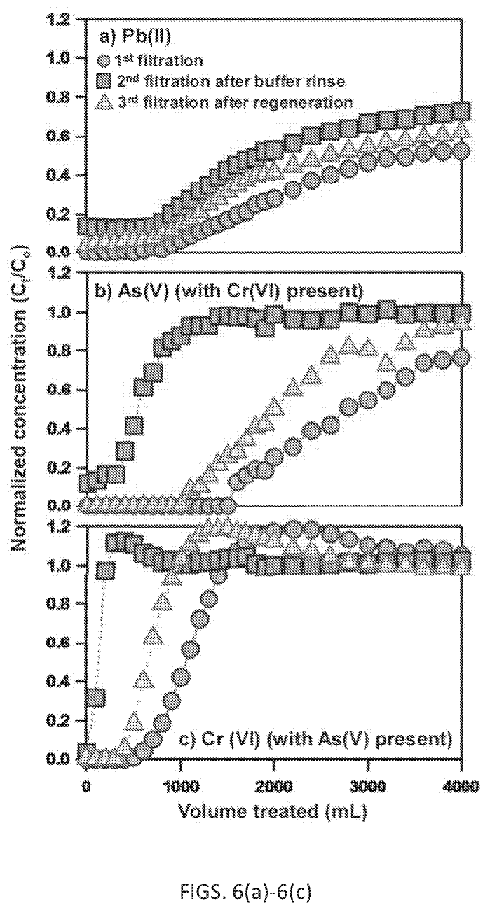

As a final demonstration, the filter removal capacity could be increased by increasing the filter thickness. For example, in accordance with an exemplary embodiment, the volume of water treated before detection of Pb(II) in the effluent (to 900 mL) was doubled by doubling the amount of PAN/Fe₂O₃@Fe₂O₃ used (to 200 mg PAN/Fe₂O₃@Fe₂O₃ with 5.7 m² available surface area) (FIG. 6(a)). The amount of Pb(II) uptake achieved during this flow-through experiment was 3.9 mg Pb(II)/g, much less than the sorption capacity determined in batch isotherms (31 mg/g), though the filter remained below saturation at the end of the experiment (i.e., effluent Pb(II) never equaled the influent concentration).

Filter regeneration. On PAN/Fe₂O₃@Fe₂O₃, both As(V) and Cr(VI) sorption proved partially reversible, as approximately (˜) 15-20% of the sorbed Pb(II)As(V) and Cr(VI) could be released into the effluent by passing clean buffer (pH 6, 10 mM MES) through the filter at the end of a filter trial (FIGS. 6(a)-6(c)). The limited reversibility of metal uptake is encouraging, as a used filter is not likely to become a significant metal source if influent quality improves. As expected, additional testing after this buffer rinse demonstrated little additional filter capacity for As(V) and Cr(VI). Larger than expected Pb(II) removal after this buffer wash likely reflects the considerable number of sites that remained available for Pb(II) binding at the end of the first trial.

More aggressive regenerative treatments were also explored. Alkaline regeneration with 1 L of 0.05 M NaOH, which has previously proven effective, resulted in the release of 85% of bound As(V) and 60% of bound Cr(VI) (FIGS. 6(b) and 6(c)). Further, metal removal with the alkaline regenerated filter was close to that of a new, pristine filter. Alternatively, treatment with 1 L of 0.1 M HNO₃ removed 50% of sorbed Pb(II), and was able to partially restore filter performance for Pb(II) removal to levels better than observed with a simple buffer wash (FIG. 6(a)).

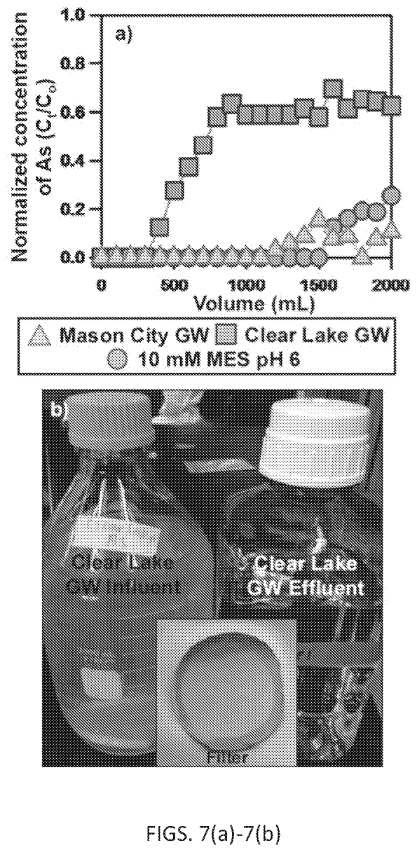

Filtration of Iowa groundwater. In using PAN/Fe₂O₃@Fe₂O₃ to treat As-contaminated groundwater, As was not immediately detectable in the treated effluent but performance was poorer than observed in idealized buffer system (10 mM MES at pH 6). For Mason City groundwater (103 ppb As), As was detectable in effluent after approximately (˜) 1,200 mL of treatment, while As in Clear Lake groundwater was detectable much more rapidly, after only approximately (˜) 400 mL (FIG. 7(a)). For Clear Lake groundwater samples (112 ppb As), the breakthrough curve noticeably plateaued at a concentration roughly 80% of the influent. This can be attributed to a pseudo-steady state condition dependent on pH and influent As concentration, where a steady rate of uptake for a portion of the total available As (with As(V) predominantly present as HAsO₄²⁻) is fast relative to flow through the filter after initial breakthrough.

Due to the higher pH of both groundwater samples relative to our model systems (pH 8.5 groundwater versus pH 6 buffer), one can expected As to break through earlier in groundwater samples when using the same amount of filter material; at pH 8.5, the surface of the PAN/Fe₂O₃@Fe₂O₃ becomes more negatively charged and thus less attractive to oxyanions like AsO₄³⁻ (as observed in pH edge experiments; see FIGS. 14(a)-14(f)). In accordance with an exemplary embodiment, it was suspected that the extensive differences in As breakthrough for the two groundwater samples may indicate that co-solutes [e.g., carbonate (CO₃²⁻) and phosphate (PO₄³⁻)] can interfere with As uptake on PAN/Fe₂O₃@Fe₂O₃, as has been reported elsewhere. In such instances, one can anticipate that the mass of PAN/Fe₂O₃@Fe₂O₃ filter could be increased to increase sorption of metals in complex water matrices where inhibition from co-solutes may occur.

Another major component of the groundwater samples was particulate matter, presumably arising from colloidal iron which may have associated As, resulting in turbid groundwater samples (initially 22 NTU). In addition to As removal, PAN/Fe₂O₃@Fe₂O₃ filters simultaneously lowered the turbidity of the treated effluent after 4 L to 0.2 NTU and removing approximately (˜) 20 mg of suspended solids from each groundwater sample that left a visible layer of solids (FIG. 7(b)). While producing a cleaner finished water, this presents a challenge in terms of colloidal fouling and regeneration. Thus, in such combined sorption and particulate filtration applications, the core-shell materials produced herein are likely best viewed as a single-use (i.e., non-reusable) technology.

As set forth above, in accordance with an exemplary embodiment, electrospinning enabled the facile synthesis of a mechanically stable nanofiber network, while hydrothermal treatment achieved a surface coating of α-Fe₂O₃ nanostructures that increased the reactive surface area available for uptake of dissolved metals.

Notably, composite nanofibers remained flexible and robust after hydrothermal treatment, as supported by strength testing, and the hydrothermal approach is easily scalable because it does not require high pressure (i.e., above 1 atm) nor high temperature (i.e., above 100° C.).

Performance of embedded (PAN/Fe₂O₃) and core-shell (PAN/Fe₂O₃@Fe₂O₃) composites for adsorption of As(V), Cr(VI), Cu(II), and Pb(II) generally matched expectations from more traditional iron oxide sorbents across a range of initial metal concentrations and pH values.

Rates and surface-area-normalized capacities for metal uptake on PAN/Fe₂O₃ and PAN/Fe₂O₃@Fe₂O₃ were also comparable to those measured in a suspension of 10 nm Fe₂O₃ nanoparticles and with a commercially available iron oxide marketed for water treatment (GFH® media).

Although both nanofiber composites exhibited comparable performance in batch systems at thermodynamic equilibrium, core-shell PAN/Fe₂O₃@Fe₂O₃ significantly outperformed PAN/Fe₂O₃ in flow-through treatment systems for As(V), Cr(VI), and Pb(II), illustrating the need for readily accessible surface binding sites in kinetically limited reactive filtration systems.

In tests with As- and particulate-contaminated groundwater, PAN/Fe₂O₃@Fe₂O₃ achieved simultaneous removal of As and suspended solids, demonstrating its viability for combined sorption and filtration treatment applications.

The small footprint of the PAN/Fe₂O₃@Fe₂O₃ nanofiber filter makes it ideal for POU and POE scenarios (e.g., by individual groundwater well users in rural areas) where larger technologies (e.g., a packed bed of GFH® media) cannot be easily utilized, particularly for Pb and As removal.

### SUPPLEMENTAL EXPERIMENTAL METHODS

Reagents. The synthesis of α-Fe₂O₃-doped PAN nanofibers required polyacrylonitrile (PAN, Aldrich, MW 150,000), N,N-dimethylformamide (DMF, BDH, 99.8%), and 10 nm α-Fe₂O₃ (hereafter Fe₂O₃) nanoparticles synthesized using ferric nitrate nonahydrate (Fe(NO₃)₃.9H₂O, Sigma-Aldrich, ≥98%). Ferric chloride heptahydrate (FeCl₃.6H₂O, Sigma-Aldrich, 97%) and L-arginine (Sigma, ≥98.5%) were used to prepare nanofibers hydrothermally coated with Fe₂O₃. Hydrochloric acid (HCl, Fisher Sci., Certified ACS Plus), sulfuric acid (H₂SO₄, Fisher Sci., Certified ACS Plus), hydroxylamine hydrochloride (Aldrich, 99%), 1,10-phenanthroline (Aldrich, ≥99%), ammonium acetate (Sigma-Alrich, ≥97%), glacial acetic acid (RPI, ≥99.7%) and ferrous ammonium sulfate (Fisher Sci., ≥99.9%) were used for acid digestion and colorimetric analysis of nanofiber iron content. HCl and sodium hydroxide (NaOH, Fisher Sci., Certified ACS) were used to clean hydrothermally treated nanofiber filters, while NaOH and nitric acid (HNO₃, Fisher Sci., Certified ACS Plus) were used in regeneration of spent nanofiber filters.

Buffer solutions prepared from either 10 mM MES hydrate (Sigma, ≥99.5%) adjusted to pH 6 and 6.5 or 10 mM HEPES (RPI, ≥99.9%) adjusted to pH 7 and 8 were used in adsorption experiments. Evoqua Water's GFH® Granular Ferric Hydroxide media was used as a commercially available iron-based sorbent for treatment efficiency comparisons. Potassium chromate (Sigma-Aldrich, ≥99.0%), sodium arsenate dibasic heptahydrate (Sigma, ≥98.0%), copper chloride dihydrate (Sigma-Alrich, ≥99.0%), and lead nitrate (Fisher Sci.) were used as pollutants in adsorption studies. Samples were treated with HNO₃ prior to analysis. Standards of 10 ppm and 100 ppm for hexavalent chromium (Cr(VI)), arsenic (As), copper (Cu), and lead (Pb) (Inorganic Ventures) were used in calibration of the inductively coupled plasma optical emission spectrometer (ICP-OES, Perkin Elmer Optima 7000 DV). Colorimetric analysis of chromate samples involved sulfuric acid (H₂SO₄, Fisher Sci., Certified ACS Plus), 1,5-diphenylcarbazide (Sigma-Aldrich, ACS reagent), and acetone (Fisher Sci., HPLC grade). All solutions were prepared in deionized (DI) water (Millipore, Milli-Q).

Nanofiber filter synthesis. To synthesize PAN nanofibers with embedded α-Fe₂O₃ nanoparticles, various amounts of α-Fe₂O₃ nanoparticles (from 8-50 wt. % relative to PAN) were suspended in 3.5 mL DMF and sonicated for 5 h. Next, 0.3 g PAN was added and the solution was thermally mixed for 2 h at 60° C. The sol gel was allowed to cool to room temperature and then electrospun with a flow rate of 0.5 mL/h at 18 kV/10 cm using a 23G needle. After 6 h, the electrospinning process was stopped and the mat was peeled off the grounded collector. The electrospinning system is described in our previous work.

Nanofiber filter characterization. Nanofiber diameter and extent of hydrothermal coating were examined with a Hitachi S-4800 scanning electron microscope (SEM), described in previous work. Samples were prepared for SEM by mounting pieces of nanofiber mats approximately 0.5 cm by 0.5 cm on Al stubs with carbon tape. Samples were sputter-coated with Au prior to imaging. SEM imaging of n=300 nanofibers (using images from 3 batches of a specified material) provided measurements used to create histograms of nanofiber diameter size, as well as determine average nanofiber diameters with standard deviation. X-ray diffraction (XRD, Rigaku MiniFlexII, cobalt X-ray source) was used to confirm the phase of nanoparticles and nanofiber coatings as hematite. Samples were prepared for XRD by placing a 1 cm by 1 cm piece of nanofiber mat on a slide with 0.2 mm well depth. Samples were analyzed from 20° to 80° for the Bragg angle with an interval of 0.02°. Specific surface area of the materials was determined via N₂-BET analysis (Quantachrome Nova 4200e) after outgassing samples at 40° C. for 6 h prior to analysis.

Speciation of Pb(II) sorbed to the surface of PAN/Fe₂O₃@Fe₂O₃ was analyzed with a Kratos Axis Ultra X-ray photoelectron spectroscopy (XPS) system equipped with a monochromatic Al Kα X-ray source. For XPS analysis, approximately 0.5 cm by 0.5 cm of PAN/Fe₂O₃@Fe₂O₃ from a Pb(II) isotherm experiment (air dried for 24 h) was placed on a sample holder using carbon tape. XPS was used to collect full spectrum survey scans, as well as to examine O 1s, C 1s, N 1s, Fe 2p, and Pb 4f regions. The mechanical strength of nanofibers and nanofiber mats was evaluated via uniaxial mechanical testing following a slightly modified protocol from our group's previous work. Briefly, nanofiber mats were cut into rectangular samples measuring 1.5 mm wide and 8 mm long. The specimens were clamped on each end so that each sample had a set gauge length of 3.6 mm. Once clamped, the position and load were zeroed, and the samples were extended to failure at a rate of 10 mm/min.

To determine iron content of materials, known masses of nanofiber mats were digested in 20 mL; of 5 M HCl overnight. 40 μL of the acid was then diluted with 960 μL of water and mixed with 30 μL of 10 g/L hydroxylamine solution to reduce Fe(III) to Fe(II). After the addition of 200 μL of 1 g/L 1,10-phenanthroline and 200 μL of 100 g/L ammonium acetate buffer, samples were analyzed colorimetrically at 510 nm with a UV-visible light spectrophotometer (Genesys 10uv) with calibration standards prepared using ferrous ammonium sulfate.

Dissolved metals analysis. For 100 ppb Cr, 1 mL of sample containing Cr(VI) was placed in a plastic cuvette and acidified with 40 μL, 5 N H2SO4. Then, 40 μL of diphenylcarbazide solution (5 mg/L in acetone) was added and the solution was mixed with a micropipette. Color was allowed to develop for 30 minutes before measuring absorbance with a UV-vis spectrophotometer at a detection wavelength of 540 nm.

### SUPPLEMENTAL RESULTS AND DISCUSSION

Competitive sorption. From pH 6.0 to 8.0, metal uptake in mixtures of Cu(II) with Pb(II) (cation-cation) and As(V) with Cu(II) (oxyanion-cation) did not differ significantly from uptake of the individual species, although Cu(II) sorption generally increased on PAN/Fe₂O₃ and PAN/Fe₂O₃@Fe₂O₃ in the presence of As(V) at pH 6 (FIGS. 17(a)-17(d)). As(V) and Cu(II) are expected to sorb at different surface sites, and the co-occurrence of bound As(V) has previously been shown to increase Cu(II) sorption by making the iron oxide surface more negative in charge. Surface precipitation of Pb(II) at high concentrations [i.e., 60 mg/L initial Pb(II)] was supported by XPS analysis (FIG. 11), in which peaks were associated with lead oxides; however, one would not expect this mechanism to be relevant in pH edge systems with the lower concentration (3 mg/L) of Pb(II) studied.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of forming core-shell iron oxide-polymer nanofiber composites, the method comprising:
synthesizing composite nanofibers of polyacrylonitrile (PAN) with embedded hematite (α-Fe₂O₃) nanoparticles via a single-pot electrospinning synthesis; and
generating a core-shell nanofiber composite through a subsequent hydrothermal growth of α-Fe₂O₃ nanostructures on the composite nanofibers of polyacrylonitrile (PAN) with the embedded hematite (α-Fe₂O₃) nanoparticles.

2. The method according to claim 1, comprising:
controlling properties of the embedded hematite composite using electrospinning synthesis variables, the electrospinning synthesis variables including size, morphology, and amount of embedded α-Fe₂O₃ nanoparticles.

3. The method according to claim 1, comprising:
tailoring the core-shell composites via hydrothermal treatment conditions, the hydrothermal conditions including soluble iron species and concentration, temperature, and duration.

4. The method according to claim 1, wherein the subsequent hydrothermal growth of the α-Fe₂O₃ nanostructures comprises:
placing the composite nanofibers of polyacrylonitrile (PAN) with embedded hematite (α-Fe₂O₃) nanoparticles in a equimolar solution of FeCl₃.6H₂O and L-arginine; and
heating the composite nanofibers of polyacrylonitrile (PAN) with embedded hematite (α-Fe₂O₃) nanoparticles in the equimolar solution of FeCl₃.6H₂O and L-arginine.

5. The method according to claim 1, comprising:
forming the core-shell nanofiber composite into a flexible sheet, mat, or membrane.

6. The method according to claim 1, wherein the embedded hematite (α-Fe₂O₃) nanoparticles have a particle size of 10 nm to 40 nm.

7. The method according to claim 6, wherein the embedded hematite (α-Fe₂O₃) nanoparticles are 8 wt. % to 50 wt. % relative to PAN.

8. The method according to claim 1, wherein the subsequent hydrothermal growth of the subsequent hydrothermal growth of the α-Fe₂O₃ nanostructures comprises:
a hydrothermal solution having a concentration of 0.07 M to 0.14 M of FeCl₃.6H₂O and L-arginine).

9. The method according to claim 1, wherein the subsequent hydrothermal growth of the subsequent hydrothermal growth of the α-Fe₂O₃ nanostructures comprises:
a hydrothermal treatment time of 1 hour to 12 hours.

10. A nanofiber composite comprising:
a core of polyacrylonitrile (PAN) with embedded hematite nanoparticles; and
a shell of Fe₂O₃ nanostructures on the core of the polyacrylonitrile (PAN) with the embedded hematite nanoparticles.

11. The nanofiber composite according to claim 10, wherein the embedded hematite nanoparticles are α-Fe₂O₃.

12. The nanofiber composite according to claim 10, wherein the Fe₂O₃ nanostructures are α-Fe₂O₃

13. The nanofiber composite according to claim 10, wherein the nanofiber composite is a sheet, mat, or membrane.

14. The nanofiber composite according to claim 13, wherein the sheet, mat or membrane is flexible.

15. The nanofiber composite according to claim 10, wherein the embedded hematite nanoparticles have a particle size of 10 nm to 40 nm.

16. The nanofiber composite according to claim 15, wherein the embedded hematite nanoparticles are 8 wt. % to 50 wt. % relative to PAN.

17. The nanofiber composite according to claim 10, wherein the nanofiber composite has an average diameter of 160±40 nm.

18. The nanofiber composite according to claim 10, wherein the nanofiber composite is used for water filtration.

19. A method for removing metal contaminations from a source of water, the method comprising:
exposing a source of water to a nanofiber composite comprising:
a core of polyacrylonitrile (PAN) with embedded hematite nanoparticles; and
a shell of Fe₂O₃ nanostructures on the core of the polyacrylonitrile (PAN) with the embedded hematite nanoparticles.

20. The method according to claim 19, wherein the nanofiber composite removes anionic As(V) and Cr(VI) and cationic Cu(II) and Pb(II) from the source of water.
